(19) United States
(12) Patent Application Publication
(10) Pub. No.: US 2013/0290820 A1
(43) Pub. Date: Oct. 31, 2013

(54) SUGGESTION OF NETWORK CONTENT ITEMS BASED ON SOCIAL NETWORK INFORMATION

(71) Applicant: Adil Dhanani, Mountain View, CA (US)

(72) Inventor: Adil Dhanani, Mountain View, CA (US)

(21) Appl. No.: 13/457,310

(22) Filed: Apr. 26, 2012

(51) Int. Cl. G06F 17/00; G06F 15/16

(52) U.S. Cl. 715/205; 709/204

(57) ABSTRACT

A method is disclosed for suggesting one or more network content items to a user. The method is performed by one or more processors of a computing device. The one or more processors analyze a plurality of social network communications posted by individuals that are associated with the user on a social network in order to detect links to content that have been posted by one or more of the individuals. One or more parameters that each correspond to the user's relationship with the one or more individuals that have posted a link on the social network are determined, and based on the one or more parameters, one or more links are selected to provide on a start page of a web browser.

### BACKGROUND

Users can operate a plurality of different computing devices, including mobile computing devices, to perform a variety of different tasks. For example, a user can use a web browser operating on a mobile computing device to view different web pages on the Internet. With the saturation of available network content, users can have a difficult time determining what to read or view.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates an example system for suggesting one or more network content items to a user, under an embodiment;

FIG. 2 illustrates an example method for suggesting one or more network content items to a user, according to an embodiment;

FIG. 3 illustrates an example user interface for suggesting one or more network content items to a user, according to an embodiment; and

FIG. 4 illustrates an example hardware diagram for a system for suggesting one or more network content items to a user, under an embodiment.

### DETAILED DESCRIPTION

Embodiments described herein determine, from social network information associated with individual users, links that are suggestive of content that may be of interest to those individual users. As examples, social network information that can be analyzed includes postings of friends, relatives, family, or persons once or twice removed from a user's direct social network connections.

According to an embodiment, a system is provided that accesses a user's social network, determines a user's relationship to individuals on the social network, and suggest one or more links to network content.

A system can suggest content to a user by displaying links or other features to suggested content items. Links to network content can be a hyperlink or uniform resource locator (URL) that is a direct or indirect reference to an internet resource. A link to network content can include links to a particular article, a video clip, an image, an audio file, a shopping page, a document (e.g., a pdf file), or other content that can be displayed as part of or as a web page on a user's web browser. In variations, the suggested content can be for content that is available through a medium other than the social networking environment, such as through television, movie theatres, books, restaurants, merchandise (e.g., online shopping), etc.

Embodiments described herein can be implemented through use of a network service (e.g., website) which can employ one or more services. In some variations, a system such as described can be implemented through, for example, a social network service, a browser plugin, an application or combination thereof. Accordingly, embodiments can be implemented on computing devices, such as a server, user-operated computing device (e.g., personal computer, tablet, mobile computing device) or combination thereof.

A “social network” can include an online service in which persons can establish accounts that link to accounts of other persons for various purpose, including the sharing of information (e.g., pictures, postings). For example, a social networking service (e.g., social network) is an online service, platform, or website that focuses on connecting users (individuals) who share interests and/or activities with others.

A plurality of social network communications that are posted on a social network by associated individuals can be analyzed in order to detect links to network content. One or more parameters that each corresponds to the user's relationship with the one or more associated individuals that have posted a link on the social network can be determined. Based on the one or more parameters, one or more links are suggested to a user.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules or components of a system. A programmatic module or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as digital cameras, digital camcorders, desktop computers, cellular or smart phones, personal digital assistants (PDAs), laptop computers, printers, digital picture frames, televisions (e.g., smart TVs) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

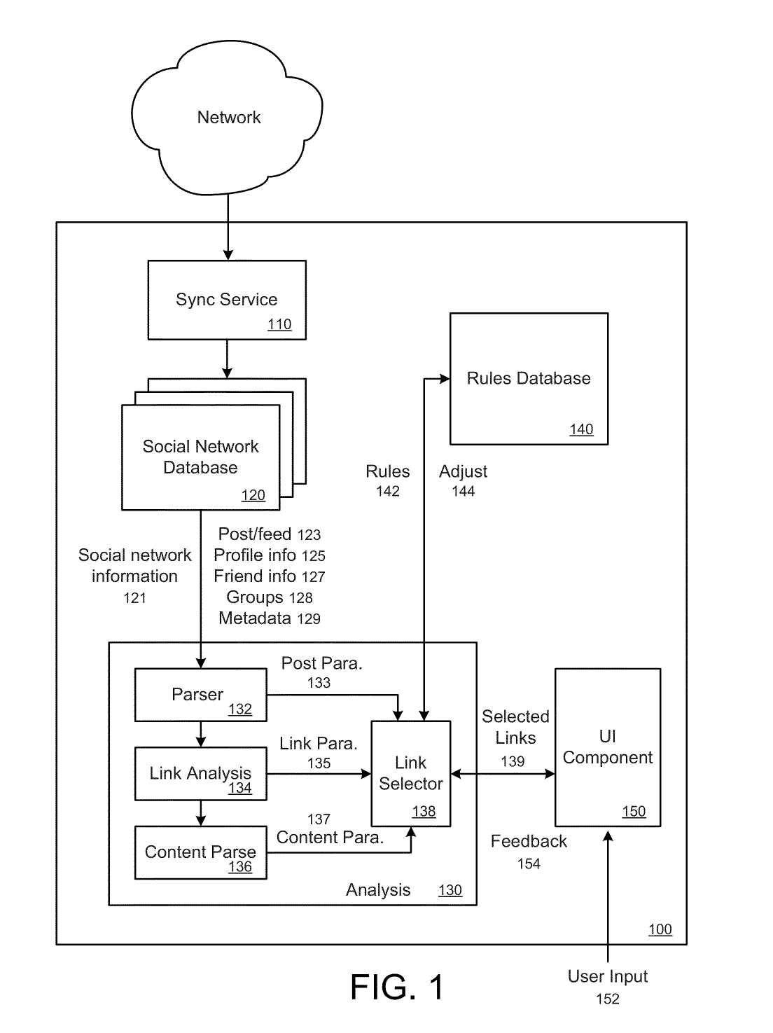

FIG. 1 illustrates an example system for suggesting one or more network content items to a user, under an embodiment. A system such as described with respect to FIG. 1 can be implemented on, for example, a small-form factor device, or other computing form factors such as tablets, notebooks, desktops computers, laptops, and the like. System 100 suggests links to content that is likely to be of interest to a user of the computing device. Links are selected based on the user's social network(s).

System 100 can be implemented with or as part of a web browser application and/or as a part of other applications (e.g., an application for a media website, such as YOUTUBE) that are executed and operated on a computing device. In other embodiments, system 100 can be implemented as a separate program or application that the web browser and/or other applications can use to suggest links to network content to a user of the computing device.

System 100 includes synchronization service 110, social network databases 120, analysis 130, rules database 140, and user interface (UI) component 150. The components of system 100 combine to analyze social network data and communications that are posted by individuals associated with a user on the social network. Based on the social network data and links posted by individuals, the components of system 100 combine to suggest to the user one or more links to network content.

System 100 includes a synchronization (sync) service 110 that is configured to synchronize or update various information for applications based on the account information of the user. In some embodiments, applications that are operated on the computing device can each include a sync service 110 to synchronize data with the particular application (e.g., synchronize calendar information with a calendar application, contact information with a contact/phone application, emails with an email application). In other embodiments, the applications can all use the same sync service 110 to update and synchronize data. Using the user's account information, the sync service 110 can receive data from the network (or Internet) and update respective social network information for each of the social networks the user is a member of. The social network information can be updated and stored in the social network database 120.

In an example provided, a social network can be tailored for certain types of users and activities, such as a dating network, or a business professional social network. Users can be a member of a number of different social networks by signing up with (e.g., joining) each of them with a particular user name or email address, and creating a profile in which other users can view. Members of a social network can be associated with each other in response to individuals requesting to join his or her social network (e.g., request to connect to the user). A user of a computing device, for example, can maintain accounts for FACEBOOK, GOOGLE PLUS, FOURSQUARE, and/or LINKED IN. Other examples of social networks can include MYSPACE, PINTEREST, TWITTER, INSTAGRAM, etc., all of which can be used to virtually connect users with other users.

In system 100, the sync service 110 can update social networking information for each of the user's social networks based on the user's respective account information. The user's account information can be stored in a memory resource of the mobile computing device or stored remotely, and accessed by the sync service 110. For example, in some operating systems of computing devices, the sync service 100 can include a database that provides a framework for enabling one or more applications, such as a web browser or an email application, to access required data from the network. The sync service 100 can also enable applications stored in the computing device to use and access data of other applications (e.g., via application programming interfaces). In one embodiment, the sync service 110 can provide the framework for enabling system 100 to access and retrieve required data from one or more social networks.

The sync service 110 can update social network information automatically or in response to certain triggers. In one embodiment, the sync service 110 can be configured to periodically request (e.g., at predetermined time intervals, such as every ten minutes) the social networking sources, such as the servers, for updated social network information. In another embodiment, the sync service 110 can receive updated social network information from the network in response to the user launching a particular application, such as the web browser or a social network application.

In some embodiments, the sync service 110 can update the social network with information provided by the user of the system 100. For example, the user can access the social network (via a web browser or social network application) in order to provide input or comments to a variety of different social networking information. The user can provide positive feedbacks (e.g., “Like” certain posts or comments), provide comments, or include his or her own links to associated individual's social network pages or profiles. The sync service 110 can update the social network with the user's provided input so that the user's associated individuals can view such content when they access the social network.

Social network information 121 can be determined from analyzing account information, profile information and/or posts and feeds (“post/feed 123”) of the user's social networking accounts. Examples of post/feed 123 can include profile information 125 pertaining to the user's profile (e.g., what a user provides as profile with a social network), information of individuals that are associated with the user (“friend information 127”), or information of groups or entities the user is associated with (“groups 128”). Updated social network information can include changes to associated individuals' profiles, requests for connecting with the user on the social network, changes to an associated individual's status or relationships, event information and invites, added photographs and/or videos, changes to a group the user is associated with, and social network communications posted by associated individuals.

The post/feed 123 can include items with symbols, characters, strings of characters and words, links to network content, images, videos or other content that an associated individual can post on the social network in a variety of different ways. The post/feed 123 can be generated from associated individual (e.g., friends) in, for example, in a text box. The post/feed 123 can also include updates, such as when a friend or user updates their own information or status (e.g., a status update). In another example, the post/feed 123 can include content that an associated individual provides on the user's wall or profile page, or on another user's wall/profile page (e.g., a wall post).

In some embodiments, the post/feed 123 can also include a message that is sent between a friend and the user using a message service on the social network (e.g., social network message). Another type of social network communication can be content provided on a comments section by an associated individual (e.g., comments post). In some cases, links that associated individuals have viewed, commented on, or provided feedback for (e.g., “like” a link) can also be automatically posted on the social network as part of the post/feed 123.

The various kinds of social network information 121 can also be provided with metadata 129. The metadata 129 can correspond to timestamps, such as for when associated individuals communicate with one another (e.g., not with the user), when an associated individual has recently viewed a network content via a link, or when an associated individual has provided a comment or feedback regarding a link that was posted on the social network.

When the sync service 110 updates social networking information for each of the user's social networks based on the user's respective account information, the social network information is updated and stored in each respective social network database 120. The social network databases 120 can also include information about the user and each of the individuals that are associated with the user. For example, a variety of different information exists corresponding to the user and a particular associated individual, such as when they became connected on the social network, the amount of shared associates (e.g., common friends), the relationship between them, the groups they are in, the shared interests, or the amount of communications exchanged between them and when they occurred. The social network databases 120 can be stored in a memory resource of the computing device. In one embodiment, the social network databases 120 can include pointers to corresponding data stored in a remote location (e.g., stored in the cloud).

Analysis 130 accesses the social network databases 120 to determine links to suggest to the user based on the user's social networking connections. In some instances, the analysis 130 can operate as a process running within the operating system of the computing device. According to an embodiment, the analysis 130 can be analyze social network information periodically (e.g., at predetermined time intervals, such as every fifteen minutes) or every time the social networking databases 120 are updated. In another embodiment, the analysis 130 can analyze social network information in response to a trigger (e.g., when the user opens an application that uses or implements the system 100, such as a web browser, or when the user provides a command via an input mechanism of the computing device).

The analysis 130 operates to analyze social network communications that are posted by associated individuals on a social network in order to detect links to content that have been posted by one or more associated individuals. In some embodiments, the analysis 130 analyzes social network communications that have been recently posted (e.g., posted since the last time the analysis 130 accessed the social network information) or have been posted within a predetermined time frame (e.g., posted during the last 24 hours). The analysis 130 also determines one or more parameters used to select links to suggest to the user. These parameters include parameters that correspond to the user's relationship with an associated individual(s) who has posted a link as part of the social network communication as well as parameters that pertain to the link itself.

The feed post 132 of the analysis 130 accesses (e.g., retrieves or receives) a plurality of social network communications that have been posted by the user's associated individuals to detect links to content that some of the associated individuals have posted. For example, on a social network, during the last hour, one of the user's friends (Friend A) may have posted a link to an article about a particular sports team, and another friend (Friend B) may have posted a link to a web page that includes a funny video. The feed post 132 can look through and analyze each of the social network communications (e.g., a status update, a wall post, a social network message, a comments post) that have been posted on the social network (and that are viewable by the user) to detect that two links have been provided by Friend A and Friend B. The detected links are provided to the link selector 138.

The feed post 132 can also determine additional information from the detected links, including one or more parameters that correspond to the user's relationship with the individuals who posted the link as part of the social network communication. The additional information can include information such as the type of social network communication the link was posted in or as a part of (e.g., a status update, a wall post, a social network message, a comments post), who the link was posted for, the name of the individual who posted the link, what device and/or the operating system the individual used to post the link, where the user was when the link was posted, and the time and date in which the link was posted.

In addition, by using information about the user and the user's associated individuals from the social network database 120, the feed post 132 can also determine the strength (or priority level) of the user's relationship with each of the individuals who have posted a link as part of the social network communication. In some embodiments, the post parameters 133 can be indicative of the user's relationship with an individual, e.g., how close of an acquaintance or friend is the individual to the user, so that the system 100 can better determine whether the user is more likely to select or view the link posted by the individual.

The post parameters 133 can correspond to the user's relationship with each individual that posted a link on the social network. They can include a classification of the individual relative to the user (e.g., the individual is related to the user, is a spouse, is a boyfriend, etc.), the number of friends the individual has in common with the user, the shared groups between the individual and user, the amount or frequency of social network communications that have been exchanged between the individual and the user, the number of times the user has selected a link that the individual has previously posted in the past, or the number of times the user has provided positive feedback to posts that the individual has previously posted on the social network (including positive feedback to links that the individual had posted). One or more of these post parameters 133 can be determined by the feed post 132 and provided to the link selector 138 with the extracted link from the social network (and the additional information).

The link analysis 134 can receive the link (e.g., the URL) and other information from the feed post 132. The link analysis 134 can analyze each link to determine meta data associated with the link as well as other parameters. In some embodiments, the link analysis 134 can also access social networking information from the databases 120 to assist in determining the link parameters 135. One or more link parameters 135 correspond to information about the link itself, such as the time and date when the link was posted, how popular the link is overall on the social network (e.g., how many times the link has been posted by other members of the social network, not just the user's associated individuals), how many members of the social network have commented on the link, how many members have talked about it, how many times the link has been reposted, etc. The link parameters 135 can also be provided to the link selector 138.

According to an embodiment, the link analysis 134 can provide the link to the content parse 136, which can analyze the content the link is identifying. The content parse 136 can obtain a variety of information about the content the link references. This information can be indicative of the overall reception or popularity of the content in the Internet community. For example, a detected link can be a URL for content, such as a video provided on a web page. The content parse 136 can identify the name of the video, when the video was posted, how many people have viewed the video or the web page in general, how many comments have been posted on the web page pertaining to the video, or how much positive feedback the video has received. These content parameters 137 can be provided to the link selector 138.

The link selector 138 of the analysis 130 receives the links, information about the links, and the various parameters (e.g., post parameters 133, link parameters 135, content parameters 137), and applies one or more rules 142 that are stored in the rules database 140. The rules database 140 can be stored in a memory resource of the computing device or stored in a remote resource. By applying one or more rules 142 to the received information, the link selector 138 can determine a ranking or evaluation score for the detected links based on social networking information. The link selector 138 can use the ranking or evaluation scores of the links in order to select one or more links to suggest to the user.

One or more of the rules 142 can be used to provide a certain weight to the parameters or to set priority levels for parameters in order to recommend a link to the user. By setting priority levels for parameters, the link selector 138 can estimate the likelihood that the user will like the recommended link (e.g., will select the link to view the respective content). For example, the strength of the user's relationship with the associated individual who posted a link on the social network may be indicative whether the user will view the content. The user may be more inclined to select a link that a father or a cousin has posted, or that a close friend has posted, compared to an associated individual the user hardly communicates with. The link selector 138 can use the post parameters 133 (e.g., how many friends the user and the associated individual who posted a link have in common, the amount of exchanged social network communications between them, how often the user commented on or provided positive feedback for a link posted by the associated individual) to determine how close the user is with the particular individual who posted the link. One or more rules 142 can be applied to prioritize a link posted by an associated individual that is deemed to have a high classification or ranking as compared to others.

For example, if the user frequently reposts or provides comments for links that a certain associated individual posts on the social network, it can be indicative that the user typically enjoys that particular individual's links that she posts. One rule 142 can provide a greater weight for a link that is posted by such an individual (e.g., prioritize the link to be higher and therefore, more likely to be suggested than another link).

The link selector 138 can also prioritize links to be suggested to the user by applying one or more rules 142 to the other parameters. For example, a rule 142 can prioritize links that have had a large number of comments or positive feedback than links with a smaller amount of comments or feedback. Similarly, a more recent link can also have a higher priority than an older link that has been around for a longer amount of time (e.g., the user may have already viewed the link if it has been around for a while). In another example, the overall reception of the content the link refers to can be important in prioritizing a link higher than other links based on another rule 142.

The link selector 138 can prioritize the detected links and select one or more links 139 to suggest to the user. Depending on user preference or default settings, for example, the number of links that can be suggested to the user can vary (e.g., recommend five links or ten links). In some embodiments, the link selector 138 can periodically update the ranking of the detected links as new links can be posted on the social network and select new or different links to suggest to the user. For example, the link selector 138 can perform the updated rankings when the analysis 130 operates periodically or when the social network databases 120 are updated. In another embodiment, the link selector suggest can update the rankings and/or select new/different links to suggest to the user when the user launches an application, such as a web browser or opens a start page of the web browser.

The link selector 138 can use a time stamp or other timing information to determine when the last time the feed post analyzed the social network communications that have been posted, or the last time the link selector 138 suggested links 139 to the user. In one embodiment, by using the time stamps or timing information, after a predetermined time, the group of selected links 139 can be reset, e.g., one or more of the selected links are removed, and one or more new links can be selected by the link selector 138. The analysis 130 can operate as a process running within the operating system of the computing device, so that suggested links are periodically updated by the link selector 138 even if the links are not displayed to the user (e.g., the user hasn't launched the web browser for hours, but associated individuals have been posting links as social network communications on the social network). The currently suggested links can then be provided by the link selector 138 when the user launches the application.

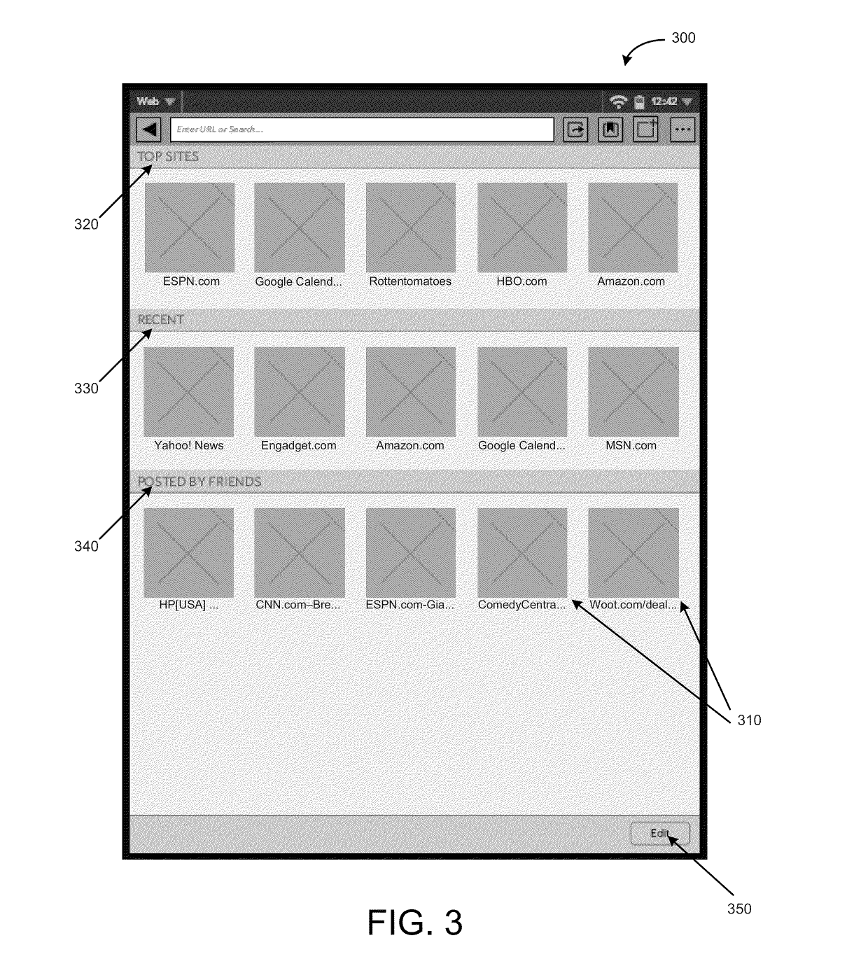

The UI component 150 receives the selected links 139 (and their associated meta data) from the link selector 138 for presenting the suggested links to the user. The UI component 150 renders the suggested links in based on different factors, such as user preference, default settings, what application is to provide the links, the type of computing device the user is operating, or the size of the display screen. According to an embodiment, the suggested links 139 can be displayed on an interface as selectable graphic features or thumbnail images in a grid like fashion (see e.g., FIG. 3), as graphic features including text corresponding to the link below (e.g., the name of the website or the content, or the link itself), as a strip, as a list, or other interface that provides the links so that the user can select one or more of the links. The selected links 139 can also be displayed so that the most highly ranked link can be posted first or in the front of the start page of the web browser, or on another application.

In one embodiment, the UI component 150 can use the information from the links and the content referenced by the links to generate a thumbnail (e.g., a portion of an image of the content, or a graphic image of an object that relates to the content or the web provider). For example, the links can be provided on a start page of a web browser, shown on a separate selection bar under the menu section of the browser, or automatically added to a folder of suggested links. The user can navigate to content by selecting a respective suggested link that is provided on the application.

The UI component 150 can also receive user input 152 (via one or more user input mechanisms of the computing device) corresponding to the user selecting a link, the user removing a link from the suggested links section of the application, or the user editing the preferences and/or settings of the suggested links section or the application. The user input 152 can be provided in response to the user interacting with the social network via a web browser or a social network application, or in response to the user interacting with the suggested links 139 that are displayed to the user on a user interface (e.g., on a UI feature of the web browser).

Based on the user input 152, the link selector 138 can receive a feedback 154 that indicates whether a particular suggested link(s) has been viewed by the user or is disliked by the user. The link selector 138 can use the feedback 154 to verify that the user liked the suggested links 139 or that the user does not particularly like the link. Using the feedback 154, the link selector 138 can add or adjust 144 one or more rules in the rules database 140 for better selecting links in the future. For example, the link selector 138 can determine that the user frequently marks links that have been posted by Friend A with a positive feedback (e.g., “Like”) on the social network. The link selector 138 can adjust 144 a rule so that a link that is posted by Friend A can be prioritized higher than a link from another friend.

In another example, the link selector 138 can determine that the user clicks on or selects a link that pertains to a particular category or sub-category (e.g., the user frequently selects on suggested links about sports, or in particular college basketball or the National Football League). Based on the user's selections or feedback information, the link selector 138 can update or adjust 144 one or more rules for prioritizing links that pertain to categories or sub-categories that are of particular interest to the user.

The system 100 can also suggest links for a user based on information from a plurality of social networks the user is a member of. Information from each social network can be stored in its respective database 120. In some embodiments, each social network can have a corresponding analysis 130. In other embodiments, the analysis 130 can use information from all of the social networks the user is a part of in order to make suggestions for the user. For example, the feed post 132 can analyze a plurality of social network communications of multiple social networks in order to detect links that have been posted by associated individuals across multiple social networks.

In some embodiments, some of the components that are described in system 100 can be provided as being individual components or as being part of the same component. For example, the rules database 140 can be provided as part of the analysis 130. In another example, the UI component 150 and the analysis 130 can be provided as part of the same component. The components that are described in system 100 can be provided as part of the device operating system or as part of one of more applications (e.g., as part of a web browser). Logic can be implemented with an application (e.g., software) and/or with hardware of the computing device.

Methodology

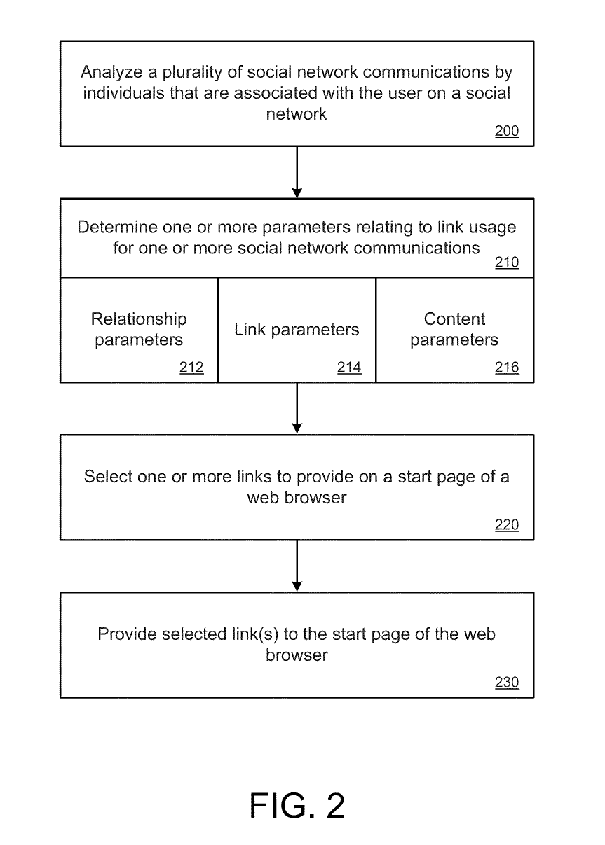

FIG. 2 illustrates an example method for suggesting one or more network content items to a user, according to an embodiment. A method such as described by an embodiment of FIG. 2 can be implemented using, for example, components described with an embodiment of FIG. 1. Accordingly, references made to elements of FIG. 1 are for purposes of illustrating a suitable element or component for performing a step or sub-step being described.

The system performs the method to suggest one or more links to network content based on social networking information of the user and individuals associated with the user. The system analyzes a plurality of social network communications posted by associated individuals on a social network to detect one or more links to content (step 200). The social network communications that are posted by the user's associated individuals include a status update, a wall post, a social network message, or a comments post. The system can also analyze other posts that are provided on the social network (e.g., on a general feed/posting section of the social network) in response to individuals' actions on the social network.

By analyzing information from the social network(s), the system can detect one or more links that have been provided on the social network as part of the social network communications. In addition, in response to analyzing the social network communications, the system can detect information about the link and the network content the link refers to. Based on the link and other information about the link, one or more parameters relating to the link and the link usage can be determined (step 210).

In some embodiments, relationship parameters can be determined (sub-step 212). Relationship parameters can each correspond to the user's relationship with an associated individual that posted a link on the social network. Relationship parameters can be indicative of the user's relationship with an individual, e.g., how close of an acquaintance or friend is the individual to the user, so that the system can better determine whether the user is more likely to select or view the link posted by the individual.

For example, relationship parameters can include a classification of the individual relative to the user, the number of friends the individual has in common with the user, the shared groups between the individual and user, the amount or frequency of social network communications that have been exchanged between the individual and the user, the number of times the user has selected a link that the individual has previously posted in the past, or the number of times the user has provided positive feedback to posts that the individual has previously posted on the social network.

The system can also determine one or more link parameters (sub-step 214) and one or more content parameters (sub-step 216). The link parameters can correspond to information about the link itself, such as the time and date when the link was posted, how popular the link is overall on the social network (e.g., how many times the link has been posted by other members of the social network, not just the user's associated individuals), how many members of the social network have commented on the link, how many members have talked about it, or how many times the link has been reposted on the social network.

The content parameters can correspond to the overall reception or popularity of the content in the Internet community. Content parameters can include information, such as when the video was posted, how many people have viewed the video or the web page in general (not just from the social network(s)), how many comments have been posted on the web page pertaining to the video, or how much positive feedback the video has received.

Based on the determined parameters, the system can select one or more links to suggest to the user (step 220). In some embodiments, the system can use one or more rules in order to select the links for the user. The rules can be applied to the various parameters to provide a ranking or prioritization. For example, links that have been posted by an associated individual that seem to have a strong relationship with the user (e.g., based on the classification of the individual relative to the user, or the number of friends they have in common, or the amount of communications exchanged) can be prioritized to be higher in suggesting the link. Similarly, links that have a high number of comments or positive feedbacks can be prioritized to be higher, and links that have been posted more than other links can also be prioritized to be higher. In some cases, a combination of rules can be used.

The selected links are then provided with an application to be displayed to a user (step 230). The application can be a web browser, a media application corresponding to an online media website (e.g., YOUTUBE application), music player application, or a social networking application. The selected links can be provided as part of a user interface for corresponding applications. For example, the suggested links can be provided on a start page of the web browser. Similarly, suggested links to media (e.g., videos or music) can be provided on a media application.

In some embodiments, the system can determine links to suggest to the user by a process running separate from an application. The suggested link(s) can then be retrieved by individual applications, such as the web browser, when the individual application is launched by the user. In other embodiments, the system can operate to determine suggested links in response to the user launching an application (e.g., as the application is being started up).

User Interface

FIG. 3 illustrates an example user interface for suggesting one or more network content items to a user, according to an embodiment. A user interface such as described by an embodiment of FIG. 3 can be implemented using, for example, components described with an embodiment of FIG. 1. The user interface 300 can be an example of a start page of a web browser (e.g., the page when the user first launches the web browser without opening a particular web page). The user interface 300 can be provided on a display (e.g., a touch-sensitive display) of the computing device. The user interface 300 includes a plurality of selectable items (e.g., graphical features) 310. Each selectable item 310 can correspond to a suggested link and can be selectable.

In some embodiments, the user interface 300 can be configured in a grid or in sections. The user interface 300 can include a first section for top sites 320, a second section for recent sites 330, and a third section for sites posted by friends 340. The third section 340, for example, can include links that have been posted by associated individuals of the user on one or more social networks (e.g., the user's friends) and have been suggested to the user by the system. When the user selects one or more of the links, a web page corresponding to the link can be automatically opened on the user interface 300 as a new page or as a separate tab. When the user selects a suggested link, the system can use the user selection as feedback to verify that the user liked the suggested link.

The user interface 300 also includes an edit feature 350, in which the user can edit one or more settings of the corresponding application or the suggested links. The user can change the number of links that are provided, add or remove sections to the user interface 300, change the manner in which the links are provided (e.g., switch from grid view to list view), or remove suggested sites that the user does not like.

Although user interface 300 is illustrated as an interface for a web browser, different applications can implement similar interfaces for providing suggested links to network content to a user.

Hardware Diagram

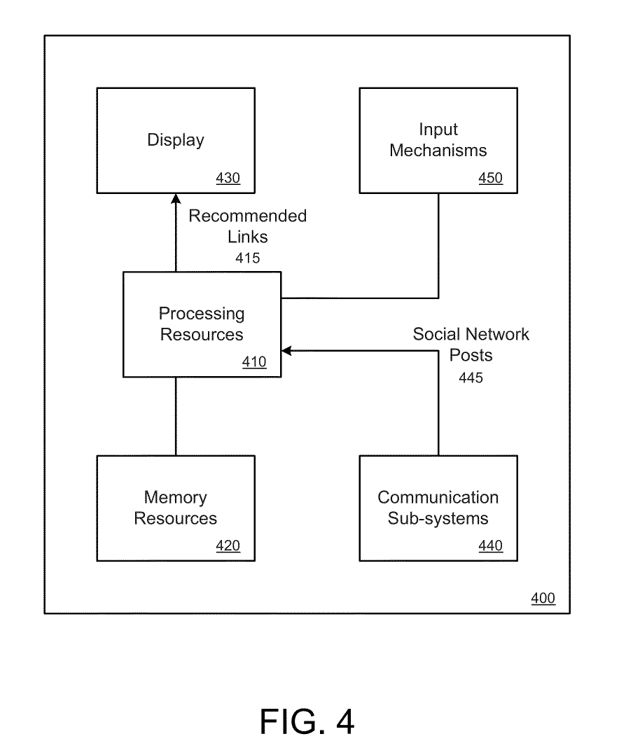

FIG. 4 illustrates an example hardware diagram of a computer system upon which embodiments described herein may be implemented. For example, in the context of FIG. 1, the system 100 may be implemented using a computer system such as described by FIG. 4. In one embodiment, a computing device 400 may correspond to a mobile computing device, such as a cellular device that is capable of telephony, messaging, and data services. Examples of such devices include smart phones, handsets or tablet devices for cellular carriers, digital cameras, or laptops and desktops (e.g., PC). Computing device 400 includes processing resources (e.g., one or more processors) 410, memory resources 420, a display device 430, one or more communication sub-systems 440 (including wireless communication sub-systems), and input mechanisms 450. In one embodiment, at least one of the communication sub-systems 440 sends and receives cellular data over data channels and voice channels.

The one or more communication sub-systems 440 can also enable wireless network connectivity with a wireless router, for example, or enable infrared (IR), radio-frequency (RF) or Bluetooth communication capabilities. Communications can be enabled via different protocols (e.g., connectivity with other devices through use of the Wi-Fi protocol (e.g., IEEE 802.11(b) or (g) standards), Bluetooth protocol, etc.). Using the one or more communication sub-systems 440, the computing device 400 can send and receive social network information, including social network posts 445.

The processing resources 410 are configured with software and/or other logic to perform one or more processes, steps and other functions described with embodiments, such as described by FIGS. 1-3, and elsewhere in the application. The processing resources 410 are configured, with instructions and data stored in the memory resources 420, to implement the system 100 (as described with FIG. 1). For example, instructions for implementing the synchronization service, the social network databases, the analysis, the rules database, and the UI component can be stored in the memory resources 420 of the computing device 400. The processing resources 410 can execute instructions for analyzing social network communications (e.g., posts) 445 that have been posted by individuals associated with the user on a social network. The processing resources 410 can also execute instructions for suggesting one or more links 415 and for providing the links to be presented on the display 430 of the computing device 400 (e.g., via a start page of a web browser).

According to an embodiment, the processing resources 410 can provide content to the display 430 by executing instructions and/or applications that are stored in the memory resources 420. For example, the content can be provided in response to a user operating a web browser. In some embodiments, the processing resources 410 can also execute and operate a variety of other applications and/or functionalities, such as, for example, a home page or start screen, an application launcher page, messaging applications (e.g., SMS messaging application, e-mail application, IM application), a phone application, game applications, calendar application, document application, clock application, camera application, media viewing application (e.g., for videos, images, audio), social media applications, financial applications, and device settings.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A method for suggesting one or more network content items to a user, the method being performed by one or more processors and comprising:
analyzing a plurality of social network communications posted by individuals that are associated with the user on a social network in order to detect links to content that have been posted by one or more of the individuals;
determining one or more parameters that each correspond to the user's relationship with the one or more individuals that have posted a link on the social network; and
based on the one or more parameters, selecting one or more links to provide with or as part of a web browser.

2. The method of claim 1, wherein analyzing the plurality of social network communications is performed periodically.

3. The method of claim 1, wherein the one or more parameters includes a number of communications exchanged between the user and each of the one or more individuals.

4. The method of claim 1, wherein the one or more parameters includes an amount of associated individuals the user and each of the one or more individuals know in common.

5. The method of claim 1, wherein selecting the one or more links to provide on the start page of the web browser includes extracting the selected one or more links from the social network communications posted on the social network and ranking the selected one or more links.

6. The method of claim 1, further comprising providing, with or as part of the web browser, one or more selectable features corresponding to the selected one or more links.

7. The method of claim 1, further comprising determining an amount of positive feedback of each of the links that have been posted by the one or more of the individuals, and wherein selecting the one or more links to provide on the start page of the web browser is also based on the determined amount of positive feedback of each of the links that have been posted by the one or more of the individuals.

8. A computing device comprising:
a display;
one or more processors coupled to the display, the one or more processors to:
analyze a plurality of social network communications posted by individuals that are associated with a user on a social network in order to detect links to content that have been posted by one or more of the individuals;
determine one or more parameters that each correspond to the user's relationship with the one or more individuals that have posted a link on the social network; and
based on the one or more parameters, select one or more links to provide with or as part of a web browser, wherein the web browser is provided on the display.

9. The image capturing device of claim 8, wherein the one or more processors analyze the plurality of social network communications periodically.

10. The image capturing device of claim 8, wherein the one or more parameters includes a number of communications exchanged between the user and each of the one or more individuals.

11. The image capturing device of claim 8, wherein the one or more parameters includes an amount of associated individuals the user and each of the one or more individuals know in common.

12. The image capturing device of claim 8, wherein the one or more processors select the one or more links to provide on the start page of the web browser by extracting the selected one or more links from the social network communications posted on the social network and by ranking the selected one or more links.

13. The image capturing device of claim 8, wherein the one or more processors further provide, with or as part of the web browser, one or more selectable features corresponding to the selected one or more links.

14. The image capturing device of claim 8, wherein the one or more processors further determine an amount of positive feedback of each of the links that have been posted by the one or more of the individuals, and wherein the one or more processors select the one or more links to provide on the start page of the web browser based on the determined amount of positive feedback of each of the links that have been posted by the one or more of the individuals.

15. A non-transitory computer readable medium storing instructions that, when executed by one or more processors, cause the one or more processors to perform steps comprising:
analyzing a plurality of social network communications posted by individuals that are associated with the user on a social network in order to detect links to content that have been posted by one or more of the individuals;
determining one or more parameters that each correspond to the user's relationship with the one or more individuals that have posted a link on the social network; and
based on the one or more parameters, selecting one or more links to provide with or as part of a web browser.
